(19) United States
(12) Patent Application Publication
(10) Pub. No.: US 2013/0011807 A1
(43) Pub. Date: Jan. 10, 2013

(54) FURNACE FOR CONDITIONING PREFORMS

(75) Inventors: Frank Winzinger, Freising (DE); Christian Holzer, Schierling (DE); Wolfgang Schoenberger, Brennberg (DE); Konrad Senn, Regensburg (DE); Andreas Wutz, Roding (DE)

(73) Assignee: KRONES AG, Neutraubling (DE)

(21) Appl. No.: 13/513,594

(22) PCT Filed: Oct. 20, 2010
(86) PCT No.: PCT/EP2010/006422

§ 371 Date: Aug. 15, 2012

(30) Foreign Application Priority Data
Dec. 4, 2009 (DE) 10 2009 047 541.9

(51) Int. Cl. B29C 49/68; B29B 13/02; F27D 11/12; B29C 49/78; F27D 19/00

(52) U.S. Cl. 432/43; 432/239; 432/49; 432/253; 392/420; 392/428; 432/1

(57) ABSTRACT

A rotary furnace for conditioning performs includes a heating wheel, a plurality of heating modules disposed on the heating wheel and a control device. Each heating module includes a heating chamber including at least one heating radiator adapted for irradiating the preform with infrared radiation, a holding and lifting device configured to lift or lower at least one of the preform and heating chamber so as to introduce the preform into the heating chamber and/or withdraw the preform from the heating chamber, and a temperature measurement device configured to measure a temperature of at least one of the preform and the heating chamber. The control device is configured to actuate the heating modules based on the measured temperature.

### CROSS REFERENCE TO RELATED APPLICATIONS

This application is a U.S. National Phase application under 35 U.S.C. §371 of International Application No. PCT/EP2010/006422, filed on Oct. 20, 2010, and claims benefit to German Patent Application No. DE 10 2009 047 541.9, filed on Dec. 4, 2009. The International Application was published in German on Jun. 9, 2011 as WO 2011/066886 A1 under PCT Article 21 (2).

### FIELD

The invention relates to a furnace of the rotary type for conditioning preforms.

### BACKGROUND

In the blow-moulding or stretch blow-moulding method containers are manufactured from so-called preforms which must be heated to a desired temperature before the actual blow-moulding stage. In order to be able to reshape the rotationally symmetrical preforms, which as a rule have standardised wall thickness values, during blow moulding into a container with a certain shape and wall thickness, individual wall sections of the preform are gradually heated in a furnace, preferably with infrared radiation. Normally, for this purpose a continuous flow of preforms is passed through a furnace with appropriately adapted irradiation sections. One problem with furnaces of this nature is however the targeted transfer of the largest proportion possible of the radiated thermal output into the preforms.

As an alternative to this, the application DE 10 2006 015853 A1 suggests that the preforms are heated in individual irradiation chambers, which in each case enclose the preforms circumferentially, wherein the individual chambers are arranged in the form of a carousel. Here, each preform is heated both by the internal wall of the chamber which is formed as a ceramic infrared radiator and also by a rod-shaped infrared radiator, which is introduced into the preform.

With the furnace in DE 10 2006 015 853 A1 it can, however, occur that individual preforms are heated to varying degrees in the heating chambers due to a tolerance of the heating chambers or heating rods one to the other and/or due to a tolerance in the positioning of the preforms in the heating chambers. In addition it would be desirable if the heating chambers and/or the heating rods adapt for the irradiation of preforms of various sizes and/or condition certain areas of the preforms specifically for a following blow-moulding process.

### SUMMARY

In view of the foregoing, there is a need for a single-chamber furnace which is suitable for preforms of different sizes and in which the preforms in all heating chambers of the furnace are heated as far as possible homogeneously.

In an embodiment, the present invention provides a rotary furnace for conditioning performs includes a heating wheel, a plurality of heating modules disposed on the heating wheel and a control device. Each heating module includes a heating chamber including at least one heating radiator adapted for irradiating the preform with infrared radiation, a holding and lifting device configured to lift or lower at least one of the preform and heating chamber so as to introduce the preform into the heating chamber and/or withdraw the preform from the heating chamber, and a temperature measurement device configured to measure a temperature of at least one of the preform and the heating chamber. The control device is configured to actuate the heating modules based on the measured temperature.

### BRIEF DESCRIPTION OF THE DRAWINGS

Exemplary embodiments of the present invention are described in more detail below with reference to the drawings, in which:

FIG. 1 shows a schematic plan view of a furnace of the radial type according to the invention;

FIGS. 2a and 2b show schematic longitudinal sections through variants of the heating chambers according to the invention;

FIG. 3 shows a schematic longitudinal section through a variant of the heating chambers according to the invention with an adjustable bottom;

FIG. 4 shows a schematic partial view of the heating module according to the invention with a heating rod adjustable in height;

FIGS. 5a and 5b show schematic longitudinal sections through variants of the heating chambers according to the invention with quick-change base plates;

FIG. 6 shows schematic longitudinal sections through quick-change heating chambers; and

FIGS. 7a to 7c show a schematic illustration of a quick-change heating rod and of the use of heating rods of different length during the irradiation of preforms with different sizes.

### DETAILED DESCRIPTION

Due to the fact that the heating modules comprise a temperature measurement device for measuring at least one temperature of the preform and/or of the heating chamber, an expected required heating energy can be more precisely estimated. Due to the fact that the furnace also comprises a control device for controlling the heating modules, in particular the heating radiators and the holding and lifting devices, based on the measured temperature, the temperature measurement values can be processed in the control device and the heating power and/or the heating duration of the individual heating modules can be set specifically in order to heat the preforms to a desired extent and as homogeneously as possible in all heating modules.

Preferably the temperature measurement device comprises a central temperature sensor on the inlet side to measure a starting temperature of the preform, and/or decentralised temperature sensors, which are provided on the heating chambers in order to measure a temperature of the heating chamber during heating. By measuring the starting temperature of the preform a target value of the heating power can be particularly determined in order to ensure a desired heating of the preform in the heating chamber. Through decentralised temperature sensors on the heating chambers the temperature rise in the heating chamber can be monitored and optionally regulated.

Preferably the control device is set up to adjust a heating power of the heating module, a heating period and/or dwell period of the preform in the heating chamber based on the measured temperature. In this way an actual discharged amount of heat, in particular an actual discharged heating energy, can be matched to a calculated target value of the amount of heat or of the heating energy.

In a particularly favourable embodiment the heating chamber comprises a bottom which can be adjusted in the axial direction with respect to the principal axis of the preform. In this way the length of the heating chamber and the length of the preform can be adapted and the same heating chamber used for preforms of different length. Changing between different sizes of heating chamber therefore becomes superfluous.

Preferably the adjustable bottom is actively heated and/or formed to reflect infrared radiation. In this way the preform can be efficiently irradiated, particularly in a bottom region of the preform.

Preferably the heating chamber comprises a plurality of heating radiators which are arranged one behind the other in the axial direction with respect to the principal axis of the preform and which can be operated separately from one another in order to adapt an active radiator area formed by the operated heating radiators to a region of the preform to be irradiated. In this way the thermal radiation can be particularly precisely adapted to the region of the preform to be irradiated. In addition, the heating radiators can be specifically switched off in a region of the heating chamber which is not to be irradiated, in particular in a region below the adjustable bottom. In this way the preform can be heated in a targeted and energy-efficient manner, and the situation can be avoided in which the heating chamber is inadmissibly heated in particular below the adjustable bottom.

In a particularly favourable embodiment the heating modules each furthermore comprise a heating rod for the irradiation of the preform with infrared radiation, and the holding and lifting device is also configured for raising and lowering the heating rod in order to introduce the heating rod into the preform or to withdraw the heating rod from it. In this way the preform can be irradiated or heated from its inner side particularly effectively and, depending on the requirement, especially targeted or especially uniformly.

Preferably a maximum depth up to which the heating rod can be introduced into the preform is adjustable. In this way it is possible on one hand to avoid the heating rod colliding with the bottom of the preform, and on the other hand that a bottom region of the preform is only inadequately irradiated or heated by the heating rod.

Preferably the heating rod has a plurality of heating radiators formed on it which are arranged one behind the other in the axial direction with respect to the principal axis of the preform and which can be operated separately from one another in order to adapt an active radiator area formed by the operated heating radiators to a region of the preform to be heated. In this way it is possible on one hand to avoid regions of the heating module outside of the preform being irradiated and possibly overheated, and on the other hand the radiator areas can be adapted in a particularly favourable manner to an irradiation of the separation edge of the preform in the neck region of the container to be blow-moulded.

In a preferred embodiment a base plate is provided on the heating chamber for a supporting ring formed on the preform, wherein the base plate is connected to the heating chamber through a plug coupling and/or a magnetic coupling for a quick change of connection. In this way the heating chamber is suitable for irradiation of the preforms with a different diameter of the supporting ring or of the part of the preform to be irradiated. With the coupling of this nature the furnace can be particularly quickly adapted for the conditioning of preforms with different dimensions.

In an advantageous embodiment base plates can be simply placed onto the heating chamber without additional plug connections. In this respect an end-stop in the radial direction is sufficient.

In a particularly favourable embodiment an axial transformer or a slip ring for the power supply of the heating modules is provided on the heating wheel and the control device is also arranged on the heating wheel so that it also rotates. In this way the number of lines required for the power supply or control of the heating modules can be reduced or the implementation of the lines simplified.

In an embodiment, the present invention also provides a method for the calibration of the heating modules of the furnace. By comparison of the effectiveness of the heating modules to be calibrated to a reference model of the heating modules, an individual correction value for each heating module can be determined in order to match the electrical energy to be applied to the individual heating modules to a common target value of the temperature increase and/or heating period.

In an embodiment the present invention also provides a method for the conditioning of preforms, in particular for the stretch blow-moulding of plastic containers, in the furnace, wherein the heating modules are individually open or closed-loop controlled based on the measured starting temperature of the preforms, so that the preforms can be reproducibly and uniformly heated in all heating modules.

In another embodiment, the present invention provides a method for the conditioning of preforms, in particular for the stretch blow-moulding of plastic containers, in the furnace according to the invention, whereby the heating modules are individually open or closed-loop controlled based on a temperature value of the preforms measured in the heating chamber so that the preforms can be reproducibly and uniformly heated in all heating modules.

Preferably the heating modules, in particular their heat energy feed and the dwell period of the preforms in the heating chambers are also open or closed-loop controlled based on the individual correction values determined in the calibration method according to the invention. In this way the individual preforms in the heating chambers can be heated especially uniformly and evenly, because both the heating period as well as the amount of heat available in the heating chambers can each be adjusted particularly uniformly and for all heating chambers essentially homogeneously.

In an alternative embodiment the preforms are accommodated in the heating chamber without being suspended and instead stand in the perpendicular direction with the mouth region facing downwards.

The furnace can be formed to heat preforms only with certain heating chambers. This may be necessary if the furnace is to be operated with a lower output of preforms. The heating chambers which are not charged remain empty here. For example it is possible to only charge each second heating chamber with a preform. Heating chambers which are not charged are preferably not heated. The distance between the preforms can be equalized after heating for blow-moulding on individual blow-moulding stations.

In a preferred embodiment a value from the container produced from the preforms is measured and fed back to the heating chamber in which the relevant preform was heated. The measured value is preferably a wall thickness of the finished container.

In a preferred embodiment the temperature is acquired at one or a plurality of radial or axial points of the preform and a correction value is fed back to the relevant heating chamber. Consequently, a heating process as uniform as possible for each preform should be achieved for each heating chamber.

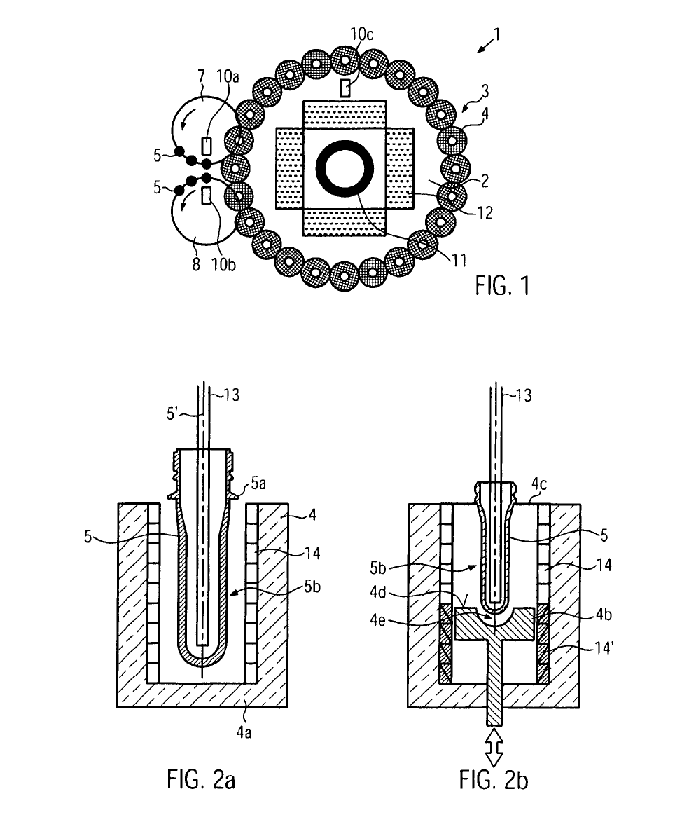

As can be seen in FIG. 1, the furnace 1 according to an embodiment of the invention is designed as a rotor and comprises a pivotably supported heating wheel 2, on which, circumferentially evenly distributed, a plurality of heating modules 3 are arranged each with a heating chamber 4 for heating a preform 5. The preforms 5 can be accepted by (not illustrated in FIG. 1) holding and lifting devices 6 from a conventional infeed star 7 and transferred, preferably lowered into the heating chambers 4. The heated preforms 5 are appropriately transferred to a conventional discharge star 8 for further processing of the preform 5 in a blow-moulding process. It would also be possible to move the heating chambers 4 using the holding and lifting devices 6.

The holding and lifting devices 6 can, for example, comprise pivotable outer or inner grippers for holding the preforms 5 and/or drives for implementing a rotary movement between the preforms 5 and the heating modules 3. Similarly, the holding and lifting devices 6 can be provided with radiation shields and/or cooling fins or cooling ducts, which however for the sake of clarity are not illustrated in the following.

Furthermore, a temperature measurement device 9 is provided, of which in FIG. 1 only temperature sensors 10a and 10c are illustrated simplified, which are arranged on the infeed star 7, the discharge star 8 or on the heating wheel 2 at each of the heating modules 3. For the sake of clarity only one of the sensors 10c is illustrated. The temperature sensor 10a on the inlet side is used to determine a starting temperature of the preforms 5 before the preforms 5 are fed into the heating modules 3. Accordingly, the outlet-side temperature sensor 10b on the discharge star 8 is designed to measure a final temperature of the preforms 5 after they have been heated in the heating modules 3. Thus, the temperature measurement device 9 comprises central or common sensors 10a, 10b which are passed by all preforms 5 consecutively. In comparison the temperature sensors 10c are designed decentrally so that the temperature measurement device 9 is designed for the separate determination or monitoring of the temperature in or on each of the heating chambers 4. The temperature measurement device 9 can comprise any combination of the temperature sensors 10a to 10c, or only the sensor 10a, 10b or the sensors 10c.

FIG. 1 also illustrates a central slip ring 11 for the power supply of the heating modules 3 and at least one control unit 12, which is configured for the processing of measurement signals from the temperature measurement device 9 and for the actuation of the heating modules 3, in particular for the control of the heating power and the heating period of the individual heating modules 3 or the dwell period of the preforms in the heating chambers 4. Since the control units 12 rotate with the heating wheel 2, they can be particularly easily connected to the temperature sensors 10c and the heating modules 3. Measurement signals from the stationary sensors 10a, 10b could, for example, be transferred by radio or through the slip ring 11 to the control unit 12. As an alternative to the slip rings 11, an axial transformer would be conceivable.

FIG. 2a illustrates a thermally insulating heating chamber 4 according to an embodiment of the invention with a stationary chamber bottom 4a and FIG. 2b illustrates an alternative variant of the heating chamber 4 with an adjustable bottom element 4b, which can be adjusted in height, i.e. along the principal axis 5′ of the preform 5 to be heated. FIGS. 2a and 2b also differ in that a comparatively longer preform 5 is introduced into the heating chamber 4 of FIG. 2a, whereas in the heating chamber 4 of the FIG. 2b a comparatively short preform 5 is introduced to the length of which the position of the bottom 4b can be adapted. Also illustrated are a central heating rod 13, adjustable in height, as an optional constituent part of the heating module 3, the insertion depth of which into the heating chamber 4 is matched to the length of the respective preform 5, as well as annular heating elements or radiators 14 stacked one above the other on the inner wall of the heating chamber 4. The preform 5 can either, as illustrated in FIG. 2a, be held above the heating chamber 4 by the (not illustrated) holding and lifting device 6 or, as illustrated in FIG. 2b, it can be placed upon a base plate 4c of the heating chamber 4 with a supporting ring 5a formed on the preform 5.

The heating elements 14 can preferably be actuated individually, so that in particular also only those heating elements 14 which are essentially situated opposite a wall section 5b of the preform 5 to be heated can be actively operated when heating the preform 5. The heating elements 14 can here also be actuated at regulated or reduced power. For example, it is conceivable that a heating element 14 is operated at half power. For clarification only those heating elements 14 are drawn white in FIG. 2b, which are essentially situated opposite the wall section 5b of the preform 5 to be heated and are actively electrically heated in the illustrated configuration, whereas the heating elements 14′ which are not activated or are switched off are drawn darkly hatched at the height of the adjustable bottom element 4b or below it. In this way it is ensured that the discharged thermal output of the heating elements 14 can be used effectively for heating the preform 5, and that simultaneously undesired heating of regions of the heating chamber 4 not to be irradiated, such as for example the side or bottom regions of the adjustable bottom 4b, is avoided.

The position of the bottom 4b, adjustable in height, can be adapted to a different length of the preforms 5, for example with the aid of an adjustment mechanism indicated in FIG. 2b by a block arrow. The surface 4d of the adjustable bottom 4b on the irradiation side is preferably implemented to reflect infrared radiation. Similarly a region 4e can be formed in the adjustable bottom 4b, in which the surface 4d on the irradiation side is adapted to the shape of the preform 5, for example in the shape of a recess. In this way the bottom region of the preform 5 can be irradiated especially effectively and uniformly.

The position of the bottom 4b, adjustable in height, could for example be set manually or automatically using the control device 12. Correspondingly, the position of the heating rod 13 above the holding and lifting device 6 could be set manually or automatically. With the heating rod 13 and bottom element 4b, which are both adjustable in height, preforms 5 with a different size can be heated with the same heating chamber 4, so that changing the heating chambers 4 when changing between preforms 5 of different size is superfluous. This reduces setup times for the furnace 1 and it dispenses with stocking a large number of different heating chambers 4 or heating rods 13.

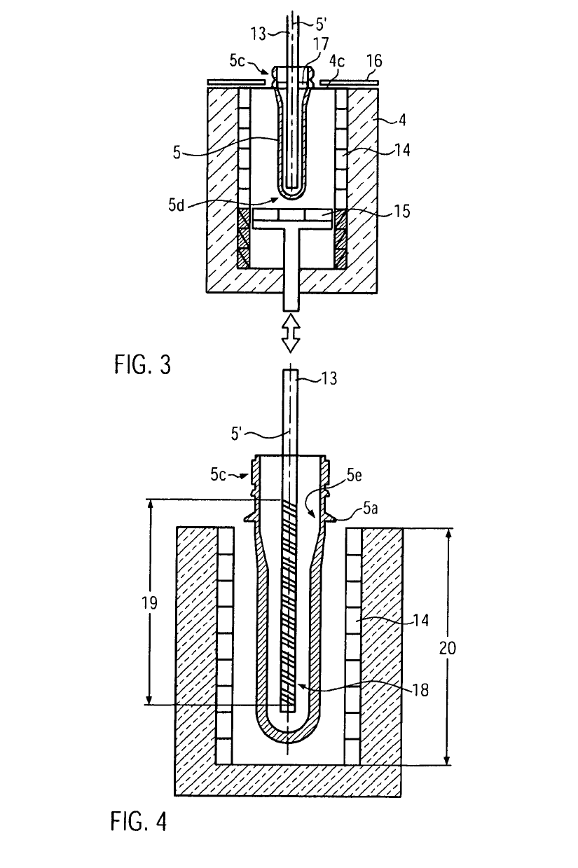

FIG. 3 shows a variant of the heating chamber 4 with a floor element 4b, adjustable in height, which comprises at least one electrically actively heated heating radiator 15. The further features of the heating chamber 4 of FIG. 3 essentially correspond to the previously described variants of the heating chamber 4, so that corresponding features are not described again. However, protective shields 16 and 17, which reflect infrared radiation and are formed in the region of the base plate 4c or are directly formed on it, are provided to shield the mouth region 5c of the preform 5 against the heat radiation given off from the heating elements 14, and the heating rod 13 in a region of the preform 5. This optical shielding, which could also be cooled additionally by an air flow or a liquid, prevents the mouth region 5c from being heated to an undesired extent to ensure adequate stability of the mouth region 5c during heating in the heating chamber 4 and in the subsequent blow-moulding process. With the actively heated heating elements 15 of the bottom 4b improved heating of the preform 5 is achieved in the bottom region 5d of the preform 5.

The adjustment of the movable bottom element 4b and/or of the heating rods 13, which can be adjusted in height, could be implemented such that all heating modules 3 are in this respect brought from an actual position into a target position during one revolution of the heating wheel 2. The bottom elements 4b and/or the heating rods 13 could then be fixed using a (not illustrated) clamping device until a new height adjustment is necessary again.

A heating rod 13, adjustable in height, is schematically illustrated in FIG. 4. In particular a plurality of heating radiators or heating elements 18, stacked one above the other, which can preferably be actuated individually, are provided on the heating rod 13 in the axial direction, i.e. along the principal axis 5′. As can also be seen in FIG. 4, the heating elements 18 of the heating rod 13 form an axial inner heating region 19, essentially corresponding to a first common radiator area of the heating elements 18 for the irradiation of the preform 5 from its inner side, and the heating elements 14 of the heating chamber 4 form an axial outer heating region 20, essentially corresponding to a second common radiator area of the heating elements 14 for the irradiation of the preform 5 from its outer side. Here the axial inner heating region 19 preferably extends further in the direction of the mouth region 5c of the preform 5 than the axial outer heating region 20. In this way the inner side 5e of the preform 5 can be targeted for irradiation, in particular in a region bordering the supporting ring 5a in order to specifically form the so-called separation edge for the subsequent blow-moulding of the container. In this respect the separation edge is designated as the point on the preform 5 at which the preform 5 is stretched under the supporting ring 5a during the blow-moulding of the container. In order to optimally form the neck region of the container, particularly to avoid a crooked neck, the axial or vertical position of the separation edge can be flexibly adapted with the aid of the heating rod 13.

This can for example be achieved in that the position of the heating radiator 18 in the region of the separation edge to be formed is moved or only individual heating radiators 18 are actively heated. Due to an inner heating of the preform 5 of this nature with the heating rod 13, the material of the preform 5 available for stretching in the blow-moulding process can be exploited to the best possible extent. This ensures in particular that the separation edge is formed at a suitable point and that as much material of the preform 5 as possible passes out of the region under the supporting ring 5a into the shoulder of the container to be formed where it ensures adequate stability.

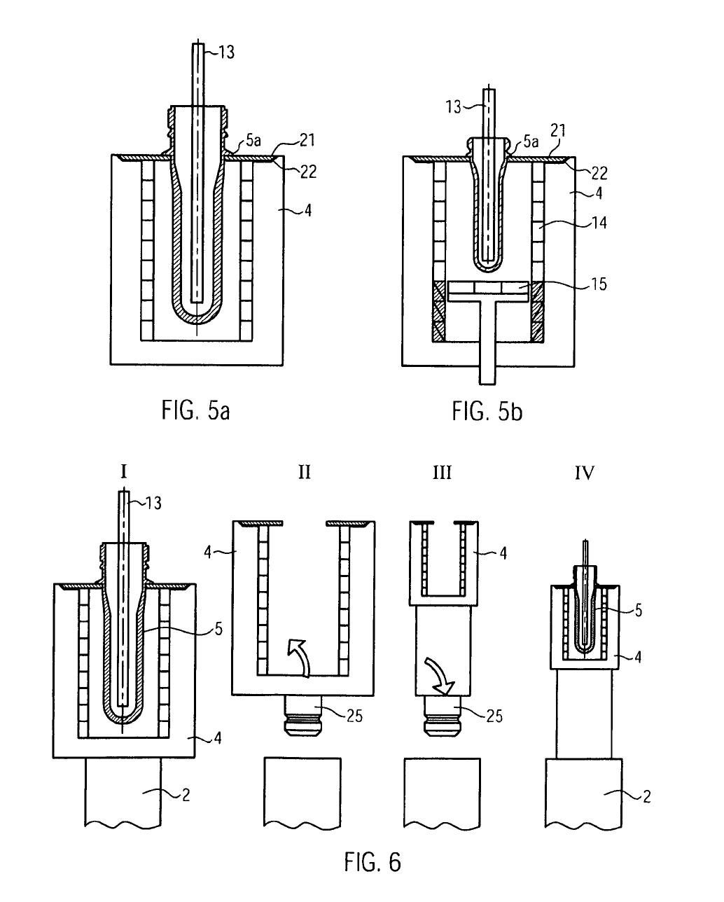

FIGS. 5a and 5b illustrate variants of the heating chamber 4, in which the base plate 4c for the supporting ring 5a of the preform 5 is implemented in the form of a quick-change base plate 21. In the example the illustrated base plates 21 are connected through a magnetic coupling 22 to the heating chamber 4. As FIGS. 5a and 5b also show, the heating modules 3 can be simply adapted in a time-saving manner with the quick-change base plate 21 to preforms 5 with different external diameters. Quick-change base plates 21 of this nature could be combined with the described variants of the heating chambers 4 as required.

Preferably the heating rod 13 is variably adjustable in the vertical direction with respect to the insertion depth in order to heat the region of the bottleneck to be formed to a varying degree. Similarly, the insertion depth of the preform into the heating chamber can be adjusted in order to heat the region of the bottleneck to a varying degree.

FIG. 6 illustrates a variant of the heating modules 3, in which the heating chamber 4 is itself designed as a quick-change component. FIG. 6 illustrates, for example at the position I, a comparatively large heating chamber 4 which is connected in a quick-change manner through a coupling 25, such as for example a plug coupling, to the heating wheel 2. This heating chamber 4 could for example be interchanged with a heating chamber 4 having an identical coupling 25 and smaller dimensions, such as indicated based on the positions II to IV. This procedure is particularly advantageous when the size of the preforms 5 differs especially substantially. In the couplings 25 suitable electrical connections or other connections required for the operation of the heating chamber 4 can be integrated.

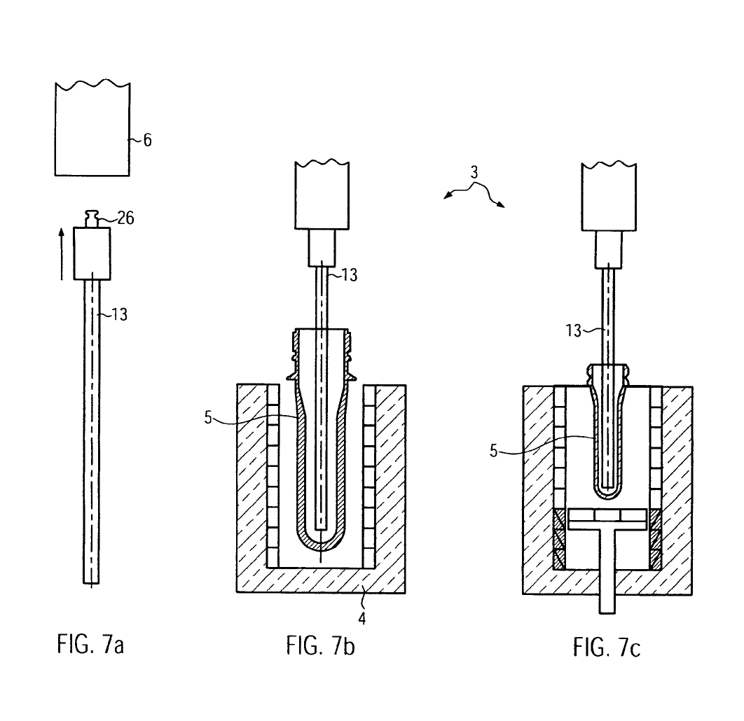

FIG. 7a shows a heating rod 13 which can be connected through a quick-change coupling 26, such as for example a plug coupling, to the holding and lifting device 6. As indicated in FIGS. 7b and 7c, it is possible to change in such a simple manner between heating rods 13 of different length and to adapt the heating modules 3 to preforms 5 of different length. For example, in this way it is possible to avoid a heating rod 13, which is too long for a preform 5, colliding with the preform 5 on lowering the heating rod 13 or that a heating rod 13, which is too short, not being lowered far enough into a preform 5 to be heated.

With the described quick-change variants of the base plate 21, the heating chamber 4 and the heating rod 13, which can be combined as required, the furnace 1 can be particularly easily and quickly reconfigured for a change of preforms 5 of different dimensions. In this respect, apart from magnetic couplings and plug couplings, other quick-change connections are conceivable in all cases.

The embodiments or variants described above can be combined in an advantageous manner as required.

In the following a method for the calibration of the furnace 1 according to an embodiment of the invention is described, especially the individual heating modules 3 or the heating chambers 4:

For manufacturing reasons the heating chambers 4 and the heating rods 13 are subject to a certain tolerance. This affects not only the shape and dimensional conformance of the heating chambers 4 and the heating rods 13, but rather also the composition of the materials, which for example may contain ceramic material mixtures, such as functional ceramics, for the constituent parts of the radiators 14, 15, 18 which are particularly relevant to the energy input, as well as the structure of the heating chambers 4 or the heating rods 13, especially with respect to the thermal transfer between individual functional components and/or material layers. For the subsequent blow-moulding process it is however desirable that the preforms 5 in the furnace 1 according to an embodiment of the invention are as reproducible as possible despite tolerances of this nature and can be heated identically to the target process temperature in all heating modules 3.

Therefore, for the types of heating chambers 4 and heating rods 13 used in the furnace 1 constructionally identical reference models 4′ and 13′ are provided to determine associated reference action coefficients 31′, 32′ as a comparison standard for the individual heating chambers 4 or heating rods 13 used in the furnace 1 through a comparative measurement.

Preferably, a reference action coefficient 33′ for the heating module 3′ consisting of the reference models 4′ and 13′ is determined, which represents a relationship between the electrical power employed and/or the duration of the electrical power feed to the heating module 3′ and the thereby resulting heating of the heating chamber 4′ and/or of a preform 5 arranged in the heating chamber 4′. Preferably, the reference action coefficient 33′ is provided for a large number of possible settings on the heating module 3″, for example for different positions of the adjustable heating chamber bottom 4b′ or the heating rods 13′ and/or a different number or arrangement of actively operated heating elements 14′, 15′ and 18′ of the reference model 3′.

For this purpose, for example, a certain electrical energy to be fed in could be specified and the associated temperature increase measured, or vice versa. Preferably, values of the reference action coefficient 33′ determined in this way are stored with the associated parameters, such as the position of the chamber bottom 4b′ in the form of a reference value table 34′ in the closed-loop control device 12. Optionally, the reference action coefficients 31′, 32′ can also be determined in separate (not further described) measurement devices and stored in appropriate reference value tables 34′. Here different variants for the calculation of comparison values are conceivable.

Before the conditioning of preforms 5 an associated individual action coefficient 33 or separate individual action coefficients 31, 32 of the individual module components 4, 13 are determined for each heating module 3 of the furnace 1. The procedure in each case corresponds to that for the associated reference model 3′ so that for each heating module 3 of the furnace 1 comparable individual action coefficients 31, 32, 33 or value tables 34 can be made available.

During the conditioning of the preforms 5 the action coefficients 31, 32 and/or 33 or the value tables 34 of individual heating modules 3 are calculated separately from one another with the reference coefficients 31′, 32′ and/or 33′ or the values of the reference tables 34′, in order to obtain an individual correction value 35 for each of the heating modules 3. This correction value 35 can be used to equalize a different heating effectiveness of the individual heating modules 3 or a different thermal efficiency in order to be able to condition the preforms 5 essentially identically in all heating modules 3. In this respect different calculation variants are conceivable, such as for example adaptive algorithms and the combination of different value tables 34 or 34′.

With the furnace 1 according to embodiments of the invention, the following method can be employed, for example:

A continuous stream of preforms 5 to be heated is fed via the infeed star 7 past the temperature sensor 10a on the inlet side, whereby the starting temperature of the preforms 5 to be heated is in each case determined and evaluated by the open and closed-loop control unit 12. The preforms 5 are then each fed to a heating module 3 of the rotating heating wheel 2 and lowered into the heating chambers 4 of the heating modules 3 by the lifting device 6.

Preferably taking the individual correction value 35 into account, an electrical target power and a target heating period is defined for each heating module 3 by the control unit 12 and the heating modules 3 appropriately heated. The heating of the preforms 5 is here checked by the decentralised temperature sensors 10c and can be adapted depending on the progression of the heating based on the temperature values acquired in this way by the control unit 12 during the heating. At the termination of heating of the preforms 5 the energy feed to the heating modules 3 is interrupted, the preforms 5 are withdrawn from the heating chambers 4 and transferred from the heating wheel 2 to the discharge star 8. Here the heated preforms 5 pass the temperature sensor 10b with which a discharge process temperature of the preforms 5 is determined or checked. The temperature determined in each case is passed to the control unit 12 which can use it to adapt the energy feed in the individual heating modules 3 for subsequent heating cycles.

The calibration and method are also particularly suitable when using adjustable heating chambers 4 and/or heating rods 13 to condition preforms 5 of different sizes under optimized conditions in each case and to ensure a reproducible, and for all heating modules 3, uniform temperature increase or temperature profile of the preforms 5.

The open and closed-loop control device 12 also facilitates a flexible actuation of individual heating modules 3. For example the control device 12 could heat only each second or third heating module 3 or charge it with a preform 5, or also any proportion of the heating modules 3 provided on the heating wheel 2, for example, to variably adapt an output capacity of the furnace 1 without changing the dwell period of the preforms 5 on the heating wheel 2 or other relevant parameters for the conditioning.

While the invention has been particularly shown and described with reference to preferred embodiments thereof, it will be understood by those skilled in the art that various changes in form and details may be made therein without departing from the spirit and scope of the invention.

1-15. (canceled)

16: A rotary furnace for conditioning performs comprising:
a heating wheel;
a plurality of heating modules, each for heating a preform, disposed on the heating wheel, each heating module including:
a heating chamber including at least one heating radiator adapted for irradiating the preform with infrared radiation,
a holding and lifting device configured to hold or lift and lower at least one of the preform and heating chamber so as to at least one of introduce the preform into the heating chamber and withdraw the preform from the heating chamber, and
a temperature measurement device configured to measure a temperature of at least one of the preform and the heating chamber; and
a control device configured to actuate the heating modules based on the measured temperature.

17: The furnace recited in claim 16, wherein the furnace is configured for stretch blowing of plastic containers.

18: The furnace recited in claim 16, wherein the control device is configured to activate the heating radiators and holding and lifting devices based on the measured temperature.

19: The furnace recited in claim 16, wherein the temperature measurement device includes at least one of a central temperature sensor disposed on an inlet side and adapted to measure a starting temperature of the preform and decentralized temperature sensors disposed on the heating chamber and adapted to measure a temperature of the heating chamber during heating.

20: The furnace recited in claim 16, wherein the control device is configured to adjust at least one of a heating power of the heating module, a heating period, and a dwell period of the preform in the heating chamber, based on the measured temperature.

21: The furnace recited in claim 16, wherein the heating chamber includes an adjustable bottom adapted to adjust in an axial direction with respect to a principal axis of the preform.

22: The furnace recited in claim 21, wherein the adjustable bottom is at least one of actively heated and configured to reflect infrared radiation.

23: The furnace recited in claim 16, wherein the heating chamber includes a plurality of heating radiators disposed one behind the other in an axial direction with respect to a principal axis of the preform, the plurality of heating radiators being separately operable so as to adapt an active radiator area formed by operated heating radiators to a region of the preform to be irradiated.

24: The furnace recited in claim 16, wherein the heating modules each include a heating rod for irradiating the preform with infrared radiation, and wherein the holding and lifting device is configured to at least one of introduce the heating rod into the preform and withdraw the heating rod from the preform.

25: The furnace recited in claim 24, wherein the heating rod is configured to be introduced into the preform to a set maximum depth.

26: The method recited in claim 24, wherein the heating rod includes a plurality of heating radiators disposed one behind another in an axial direction with respect to a principal axis of the preform, the plurality of heating radiators being configured to be operated separately from one another so as to adapt an active radiator area, corresponding to the operated heating radiators, to a region of the preform to be heated.

27: The method recited in claim 16, further comprising a base plate disposed on the heating chamber for a supporting ring formed on the preform, the base plate being connected to the heating chamber through at least one of a plug coupling and a magnetic coupling so as to enable quick change of connection.

28: The method recited in claim 16, further comprising at least one of an axial transformer and a slip ring disposed on the heating wheel for supplying power to the heating modules, wherein the control device is also dispose don the heating wheel so as to rotate.

29: A method for calibrating heating modules of a furnace, the method comprising:
providing a heating furnace including:
a heating wheel;
a plurality of heating modules, each for heating a preform, disposed on the heating wheel, each heating module including a heating chamber including at least one heating radiator adapted for irradiating the preform with infrared radiation, a holding and lifting device configured to hold or lift and lower at least one of the preform and heating chamber so as to at least one of introduce the preform into the heating chamber and withdraw the preform from the heating chamber, and a temperature measurement device configured to measure a temperature of at least one of the preform and the heating chamber; and
a control device configured to actuate the heating modules based on the measured temperature;
providing a reference model of the heating modules;
heating at least one heating element of the reference model by feeding electrical energy and measuring a temperature of the reference model;
determining a reference action coefficient for the reference model that represents a relationship between a measured temperature and at least one of a supplied electrical power and a duration of electrical power feed;
calculating an individual correction value of the heating modules for conditioning the performs in the heating modules based on the action coefficients.

30: A method for conditioning preforms, the method comprising:
providing a heating furnace including:
a heating wheel;
a plurality of heating modules, each for heating a preform, disposed on the heating wheel, each heating module including a heating chamber including at least one heating radiator adapted for irradiating the preform with infrared radiation, a holding and lifting device configured to hold or lift and lower at least one of the preform and heating chamber so as to at least one of introduce the preform into the heating chamber and withdraw the preform from the heating chamber, and a temperature measurement device configured to measure a temperature of at least one of the preform and the heating chamber; and
a control device configured to actuate the heating modules based on the measured temperature;
measuring a starting temperature of the performs;
introducing the performs into each of the heating modules; and
heating the performs by at least one of actuating and controlling the heating modules based on respective measured starting temperatures of the performs.

31: The method recited in claim 30, wherein the method is configured for conditioning the performs for stretch blow-molding plastic containers.

32: The method recited in claim 30, wherein the at least one of actuating and controlling of the heating modules includes controlling a heat energy supply of the heating modules and a dwell period of the performs in the heating chambers.

33: The method recited in claim 31, further comprising:
calibrating the heating modules by a method including:
providing a reference model of the heating modules;
heating at least one heating element of the reference model by feeding electrical energy and measuring a temperature of the reference model;
determining a reference action coefficient for the reference model that represents a relationship between a measured temperature and at least one of a supplied electrical power and a duration of electrical power feed;
calculating an individual correction value of the heating modules for conditioning the performs in the heating modules based on the action coefficients; and
wherein the at least one of actuating and controlling the heating modules is based on the respective individual correction values.

34: A method for conditioning preforms, the method comprising:
providing a heating furnace including:
a heating wheel;
a plurality of heating modules, each for heating a preform, disposed on the heating wheel, each heating module including a heating chamber including at least one heating radiator adapted for irradiating the preform with infrared radiation, a holding and lifting device configured to hold or lift and lower at least one of the preform and heating chamber so as to at least one of introduce the preform into the heating chamber and withdraw the preform from the heating chamber, and a temperature measurement device configured to measure a temperature of at least one of the preform and the heating chamber; and
a control device configured to actuate the heating modules based on the measured temperature;
introducing the performs into each of the heating modules;
heating the performs and measuring at least one temperature value of the heating chamber during heating; and
actuating or controlling the heating modules individually based on the respective measured temperature value.

35: The method recited in claim 34, further comprising:
calibrating the heating modules by a method including:
providing a reference model of the heating modules;
heating at least one heating element of the reference model by feeding electrical energy and measuring a temperature of the reference model;
determining a reference action coefficient for the reference model that represents a relationship between a measured temperature and at least one of a supplied electrical power and a duration of electrical power feed;
calculating an individual correction value of the heating modules for conditioning the performs in the heating modules based on the action coefficients; and
wherein the actuating or controlling the heating modules is based on the respective individual correction values.
